(19) United States
(12) Patent Application Publication
(10) Pub. No.: US 2002/0070475 A1
(43) Pub. Date: Jun. 13, 2002

(54) Methods of continuously forming an insulated body

(76) Inventors: Daniel F. Schneider III, House Springs, MO (US); William R. Smith, Houston, TX (US)

Correspondence Address: SENNIGER POWERS LEAVITT AND ROEDEL, ONE METROPOLITAN SQUARE, 16TH FLOOR, ST LOUIS, MO, 63102, US

(21) Appl. No.: 09/734,441

(22) Filed: Dec. 11, 2000

(51) Int. Cl. B29C 47/06; B29D 23/00; B32B 1/08; B32B 31/30

(52) U.S. Cl. 264/171.13; 264/171.26

(57) ABSTRACT

A method of continuously insulating a body of substantially uniform cross-section, such as a pipeline, so that it can be either wound on a reel for transportation to a site where it can then be unreeled, or by allowing the application of the insulation on location as the pipeline is unreeled. The steps of the method comprise: placing a beginning portion of the body in a casting section of a mold having a body inlet and a body outlet; injecting insulative material into the casting section of the mold so as to surround the beginning portion of the body; continuously moving the body through the casting section of the mold while continuing to supply sufficient insulative material to the casting section of the mold to surround the body as it passes through the casting section of the mold; continuously passing the body and insulative coating through a curing section of the mold immediately down stream of the body outlet of the mold; and continuously removing the body and cured insulative coating from the curing section.

### BACKGROUND OF THE INVENTION

The present invention relates to methods of continuously forming an insulated body of substantially continuous cross-section and more particularly for continuously applying an insulative coating to a pipeline for undersea use.

Long lengths of pipe are used in undersea installations for the recovery and transportation of crude oil from well heads. Because large lengths of this pipeline are needed to cover long distances, it is desirable to transport the pipe in a reel form and then unreel the pipeline as it is being laid on the ocean floor so that as few joints as possible have to be made in the pipe when it is being laid. When pipelines are to be laid at great ocean depths it is necessary to insulate the pipe so that the crude oil will flow at an acceptable flow rate through the pipe for long distances. A commonly used method of insulating such pipe has been to use a pipe within a pipe with or without an insulative material between the walls of the two pipes. However, since, when insulated, the two pipes can move relative to one another when they are being wound on large reels, transported or installed, it is common for the insulation to be torn and damaged since it is sheared within the two pipes as they move relative to one another. This results in permanent voids or uninsulated areas that reduce the overall effectiveness of the insulative filler.

Conventional existing insulations applied to the exterior of single pipe and used for undersea pipelines have not been able to be mechanically formed into complex curved shapes, nor wound on a reel for transportation to a location where it is to be unwound and placed on the ocean floor. This is because conventional rigid insulation, and solid thermoplastic polymers are crushed and/or permanently deformed by the winding process and/or during bending and/or during the installation process, thus losing or reducing their insulative properties. In addition, there has not been a method devised to apply insulation at the site where the pipeline is being put down, such as on a barge where the uninsulated pipe is unreeled from a spool.

A newer form of insulation, such as that proposed in U.S. patent application Ser. No. 09/546,033, filed Apr. 10, 2000, assigned to the same assignee as the present invention and incorporated herein by reference, proposes the use of a single pipe with a layer of insulation formed on the outside thereof from particular polymers with a glass or ceramic hollow microsphere filling which provides the necessary crush resistant at the great depths at which such pipelines are laid for undersea installations.

### SUMMARY OF THE INVENTION

The present invention overcomes the above described difficulties and disadvantages of the prior art by providing a method of continuously insulating a body of substantially uniform cross-section, such as a pipeline, so that it can be either wound on a reel for transportation to a site where it can then be unreeled, or by allowing the application of the insulation on location as the pipeline is unreeled. These advantages are provided by a continuous method for the casting of an insulative coating on the outside of a substantially uniform cross-section body wherein the steps comprise: placing a beginning portion of the body in a casting section of a mold having a body inlet and a body outlet; injecting insulative material into the casting section of the mold so as to surround the beginning portion of the body; continuously moving the body through the casting section of the mold while continuing to supply sufficient insulative material to the casting section of the mold to surround the body as it passes through the casting section of the mold; continuously passing the coated body through a curing section of the mold immediately down stream of the body outlet of the mold; and continuously removing the coated body from the curing section. Preferably, the body inlet is of substantially the same cross-section as the body so as to prevent leakage of the insulative material from the mold and the body outlet is substantially the same cross-section as the desired final dimensions of the insulative coating formed on the body. Also, the method also preferably includes the steps of: heating a portion of the body to a predetermined temperature as it enters the body inlet of the mold; maintaining the casting section of the mold at a predetermined temperature during practice of the method; and maintaining the curing section of the mold at a predetermined temperature during practice of the method. The method also preferably includes the body being moved through the mold at a predetermined temperature such that the insulative coating is sufficiently stabilized as it leaves the mold that it will maintain its shape. The method also further preferably includes in the step of injecting an insulative coating, injecting a mixed polymeric and microsphere material into the casting section of the mold so as to completely encase the outer surface of the body as it passes through the casting section.

Other objects and features will be in part apparent and in part pointed out hereinafter.

### BRIEF DESCRIPTION OF THE DRAWINGS

FIG. 1 is a cross-sectional view of a pipe with an insulative coating thereon;

FIG. 2 is a schematic illustration of a mold and pipe transport mechanism used in the method of the present invention; and

FIG. 3 is a schematic layout of the equipment utilized to supply insulative material to the mold.

Corresponding reference characters indicate corresponding parts throughout the drawings.

### DESCRIPTION OF THE PREFERRED EMBODIMENT

The following describes a procedure for the continuous casting of insulative material such as that disclosed in the above referred to U.S. patent application Ser. No. 09/546,033.

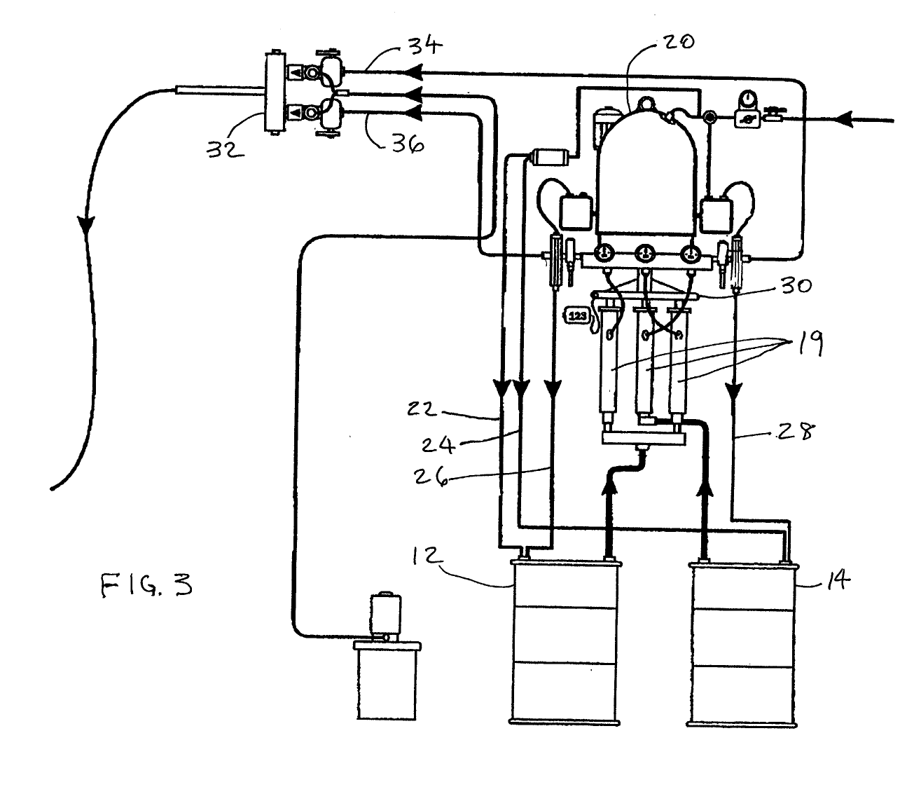

The reactive materials that are described in the abovereferenced application are introduced into a conventional mixing apparatus, shown schematically in FIG. 3, where they are combined in the correct ratio and thoroughly mixed. Since this apparatus is considered conventional and well known in the industry, only a brief description will be provided. The components of the insulative material are provided in the barrels 12 and 14, one of which would be the resin and the other the catalyst. The base component containing the microspheres of 10-40% and preferably 25-33% by volume is mixed in a three to one ratio with the catalyst prior to hooking the barrels up to the apparatus. Suction lines 16 and 18 are attached to barrels 12 and 14 respectively at one end and to airless pumps 19 at their opposite ends for withdrawing the components from the barrels. An air motor 20, pressurized lines 22 and 24 as well as recirculation lines 26 and 28 provide the pressure in the barrels for removing the contents therefrom. The components are feed through a manifold 30 to separate inputs into a static mixer 32 via lines 34 and 36 where the insulative coating mixture 37 is blended together.

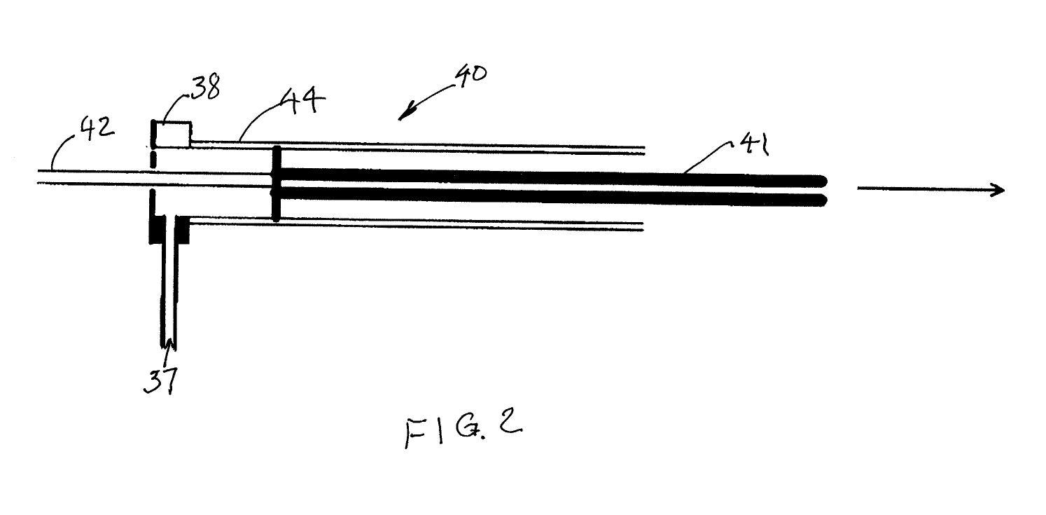

This mixture 37 is immediately dispensed into a casting section 38 of a mold 40, shown schematically in FIG. 2, that is configured to dispense a predetermined thickness, in a predetermined configuration, of the composite material to the exterior of a pipe 42. The thickness of the composite material is determined by the thermal insulation requirements desired. The pipe 42 is continuously drawn through the mold 40 by a pulling mechanism 41 as the insulative coating is introduced to the casting section 38. The coated pipe 43 emerges from the casting section 38 of mold 40 and passes into a curing section 44, preferably heated such as discussed in the example below, where curing is completed sufficiently that the insulative coating will retain its shape as it leaves the mold. Typically, the coating emerges in a cured state and can be immediately handled.

Depending on specific requirements, as the insulatively coated pipe 42 exits the curing section 44 it may be force cooled with water sprayed directly on to it, or other suitable means. The continuous casting equipment may be configured to coat various lengths of pipe, commonly referred to as joints, and including coils or reels of pipe. If in the form of coils or reels, the pipe would be uncoiled and straightened before passing into the casting section 38. If in the initial form of coils or reels, it could be recoiled or reeled after insulation is applied, or it could be cut into lengths. In the case of undersea installation, the lengths of pipe can be joined together after the insulative coating is applied and then immediately laid down on the ocean floor.

If in either the form of joints of varying length, or coils, the pipe may undergo various forms of chemical or mechanical cleaning and/or surface preparation, including, but not limited to abrasive blasting, and/or priming with various commercially available paint or coatings products before the insulation material is applied to the pipe.

### EXAMPLE

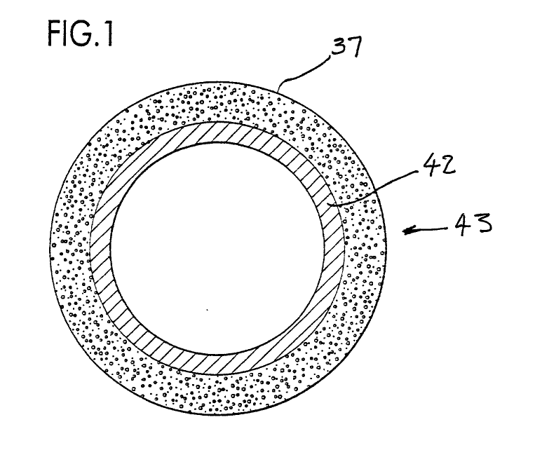

The insulative material described in U.S. patent application Ser. No. 09/546,033, filed Apr. 10, 2000, was applied at a nominal thickness of 1.5 inches to a one-inch pipe with a nominal outer diameter of 1.25 inches, as shown in FIG. 1.

Lengths of one-inch pipe of a nominal outer diameter of 1.25 inches were cleaned to remove contaminants and abrasive blasted to a cleanliness as specified by the Steel Structures Painting Council Standard “SSPC-SP5” (White Metal Blast) with a minimum profile of 3.5 mils (0.0035 inches). After abrasive blasting, one end of the pipe was inserted into the casting portion of the mold and attached to a mechanism 41 that maintains the pipe in the center of the mold and pulls the pipe through the mold during the processing. The one-inch pipe was then heated to approximately 175° F. by circulating heated air through it. The opening inlet opening to the casting section of the mold is nominally the same size as the outside diameter of the pipe so that little or no insulative material leaks out of the mold.

The insulative coating was dispensed into the casting portion of the mold of approximately 3 inches in length and maintained at a temperature of approximately 150° F., until it is filled, at which point the mechanism to pull the pipe through the mold was started. The flow of the material was monitored to keep the casting portion of the mold full as the pipe passes through it. The insulated pipe 43 enters a curing section of approximately 36 inches in length with the same cross sectional configuration as the casting portion of the mold. The curing section was maintained at approximately 150° F. for the first 12 inches gradually increasing to approximately 225° F. over the next 12 inches. The final 12 inches was maintained at approximately 225° F.

The speed of the pipe was maintained at approximately 2 inches per minute. The coated pipe emerged from the curing section and was allowed to air cool until the trailing end emerged from the curing section. At this point the coated pipe section was removed and stacked on a rack and the procedure repeated with another one-inch pipe section.

The speed of the pipe was varied from run to run with a maximum speed of 2.7 inches per minute being obtained. At that speed this particular formulation of the insulation material was not sufficiently cured to maintain dimensional stability as it exited the curing section.

It was determined that a speed of 2 inches per minute was best for the particular formulation tested. This allowed a residence time of approximately 7 minutes at 225° F. in the curing section of the mold.

In view of the above, it will be seen that the several objects of the invention are achieved and other advantageous results attained.

As various changes could be made in the above methods, without departing from the scope of the invention, it is intended that all matter contained in the above description and shown in the accompanying drawings shall be interpreted as illustrative and not in a limiting sense.

What is claimed is:

1. A continuous method for the casting of an insulative coating on the outside of a substantially uniform cross-section body, the steps comprising:
placing a beginning portion of the body in a casting section of a mold having a body inlet and a body outlet;
injecting insulative material into the casting section of the mold so as to surround the beginning portion of the body;
continuously moving the body through the casting section of the mold while continuing to supply sufficient insulative material to the casting section of the mold to surround the body as it passes through the casting section of the mold;
continuously passing the coated body through a curing section of the mold immediately down stream of the body outlet of the mold; and
continuously removing the coated body from the curing section.

2. The method of claim 1 wherein the body inlet is of substantially the same cross-section as the body so as to prevent leakage of the insulative material from the mold and the body outlet is substantially the same cross-section as the desired final dimensions of the insulative coating formed on the body.

3. The method of claim 2, including the step of:
heating a portion of the body to a predetermined temperature as it enters the body inlet of the mold;
maintaining the casting section of the mold at a predetermined temperature during practice of the method; and
maintaining the curing section of the mold at a predetermined temperature during practice of the method.

4. The method of claim 3 wherein the body is moved through the mold at a predetermined temperature such that the insulative coating is sufficiently stabilized as it leaves the mold that it will maintain its shape.

5. The method of claim 3 wherein the step of injecting an insulative coating includes injecting a mixed polymeric and microsphere material into the casting section of the mold so as to completely encase the outer surface of the body as it passes through the casting section.

6. The method of claim 1 including wherein the body to be coated is a pipe and includes the step of unreeling the pipe from a reel before introducing it into the casting section of the mold.

7. The method of claim 6 including the step of reeling the coated pipe onto a reel after it has been coated.

8. The method of claim 6 wherein the coated pipe is laid on the ocean floor immediately after the insulative material is applied.
